(19) United States
(12) Patent Application Publication
(10) Pub. No.: US 2010/0131141 A1
(43) Pub. Date: May 27, 2010

(54) BANK ANGLE ESTIMATION VIA VEHICLE LATERAL VELOCITY WITH FORCE TABLES

(75) Inventors: Jihan Ryu, Rochester Hills, MI (US); Flavio Nardi, Farmington Hills, MI (US); Nikolai K. Moshchuk, Grosse Pointe, MI (US); Kevin A. O'dea, Ann Arbor, MI (US)

Correspondence Address: MILLER IP GROUP, PLC;GENERAL MOTORS CORPORATION, 42690 WOODWARD AVENUE, SUITE 200, BLOOMFIELD HILLS, MI, 48304, US

(73) Assignee: GM GLOBAL TECHNOLOGY OPERATIONS, INC., DETROIT, MI (US)

(21) Appl. No.: 12/275,856

(22) Filed: Nov. 21, 2008

(51) Int. Cl. B60W 30/02

(52) U.S. Cl. 701/29

(57) ABSTRACT

A method for road bank detection that has particular application in vehicle stability control systems and vehicle roll-over avoidance systems. The method for detection of a road bank includes obtaining a yaw rate value and a front and/or rear axle force value for a vehicle travelling on the road. It further includes comparing the obtained vehicle yaw rate value with a corresponding predetermined vehicle yaw rate value to obtain a vehicle yaw rate error value and comparing the obtained vehicle front and/or rear axle force value with a corresponding predetermined vehicle front and/or rear axle force value to obtain a vehicle front and/or rear axle force error value, and detecting the road bank based on the obtained vehicle yaw rate error value and the vehicle front and/or rear axle force error value.

### BACKGROUND OF THE INVENTION

1. Field of the Invention

This invention relates generally to a system and method for detecting road bank and, more particularly, to a system and method for detecting road bank using vehicle yaw rate and vehicle front or rear axle forces.

2. Description of the Related Art

Most modern vehicles are typically equipped with electronic stability control (ESC) systems that ensure the safety of the occupants of the vehicle during unstable driving conditions. An ESC system constantly monitors vehicle conditions and is activated to stabilize the vehicle in the event that certain vehicle states, such as yaw rate, lateral velocity and the like, change in a way so as to reflect an unstable condition. An unstable condition may occur in situations where the vehicle is turning too fast, which presents a risk of the vehicle losing control and possibly rolling over. Although known ESC systems address most unstable conditions, there are certain situations where the ESC system is not activated or wrongly activated. One such situation is the presence of a road bank which may act as a false alarm for the ESC system because certain vehicle states, such as yaw rate and lateral acceleration, when the vehicle is on the bank resemble states corresponding to unstable conditions. Thus, it is necessary to detect when the vehicle is on a road bank.

Known ESC systems typically provide road bank detection using two basic approaches. The first approach is to follow a case-logic analysis. This approach obtains vehicle states, such as lateral acceleration, yaw rate, etc., and compares these values with values obtained when the vehicle is made to traverse a banked road during testing. If a strong correlation is obtained, the system assumes a road bank is present. However, such an approach is limited by the number of simulations used during testing and hence is not exhaustive in nature.

A second approach for road bank detection is to filter the obtained signals from the vehicle sensors, in particular lateral acceleration and the lateral velocity derivative. An increase in lateral acceleration indicates the presence of a road bank. However, this approach is not entirely conclusive in terms of bank detection as an offset in the filtered lateral acceleration can be induced by conditions other than a bank.

Further, in the case of a vehicle traveling on a banked road, a bias is induced by a force component due to gravity. As a result, the vehicle parameters change in a way that could make them appear as error values to the ESC system.

Another problematic situation arises when the vehicle is traveling on a path having a low coefficient of friction p, such as ice. A road bank is equivalent to a slow turn on ice or snow for the ESC system, which is unable to differentiate between the two conditions.

### SUMMARY OF THE INVENTION

In accordance with the teachings of the present invention, a method for road bank detection is disclosed that has particular application in vehicle stability control systems and vehicle roll-over avoidance systems. The method includes obtaining a yaw rate value and a front or rear axle force value for a vehicle travelling on a road. The method compares the yaw rate value with a corresponding predetermined vehicle yaw rate value to obtain a vehicle yaw rate error value and compares the obtained vehicle front or rear axle force value with a corresponding predetermined vehicle front or rear axle force value to obtain a vehicle front axle force error value. The road bank detection is based on the vehicle yaw rate error value and the vehicle front or rear axle force error value.

Additional features of the present invention will become apparent from the following description and appended claims, taken in conjunction with the accompanying drawings.

### BRIEF DESCRIPTION OF THE DRAWINGS

FIG. 1 illustrates a front view of a vehicle traveling on a banked road;

FIG. 2 is a flow diagram illustrating method steps for an algorithm that provides road bank detection;

FIGS. 3 and 4 are exemplary graphical representations of the variation of yaw rate and front axle force values, respectively, for a vehicle traveling on ice;

FIGS. 5 and 6 are exemplary graphical representations of the variation of yaw rate values and front axle force values for a vehicle traveling on a banked road; and

FIG. 7 is an exemplary graphical variation of front lateral force values as a function of front axle slip angle for a vehicle traveling on a road.

### DETAILED DESCRIPTION OF THE EMBODIMENTS

The following discussion of the embodiments of the invention directed to a method for providing road bank detection is merely exemplary in nature, and is in no way intended to limit the invention or its applications or uses. For example, the method for road bank detection of the invention may have application in vehicle stability control systems and vehicle roll-over avoidance systems. However, as will be appreciated by those skilled in the art, the method for road bank detection of the invention may have other applications.

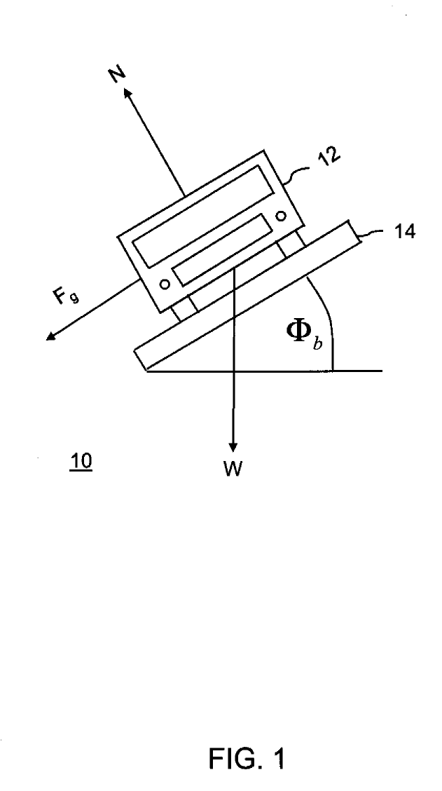

FIG. 1 is a front view of a vehicle 12 traveling on a banked road 14. Roads are typically banked on curves to allow a vehicle to undertake the curve at high speeds without losing control. The bank introduces a force component due to gravity F_{g}, which balances the vehicle 12 at high speeds and prevents it from sliding out of the curve. The value N is the normal reaction on the vehicle 12 due to the road and the value W is the weight of the vehicle 12. Under normal circumstances for a vehicle traveling on an unbanked flat road in a stable manner, vehicle conditions are indicated by low magnitudes of yaw rate error, lateral acceleration or steering wheel movement. Unstable conditions, such as sliding and skidding, of the vehicle 12 also get reflected in these states. Hence, these states may be constantly monitored by an electronic stability control (ESC) system of the vehicle 12.

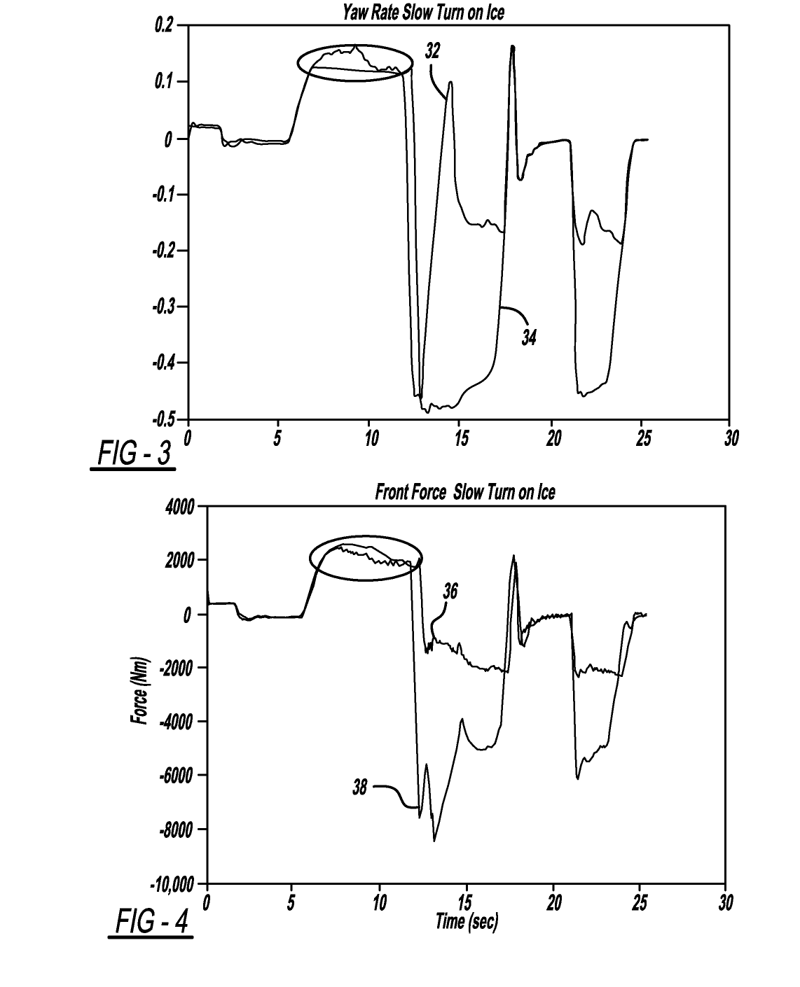

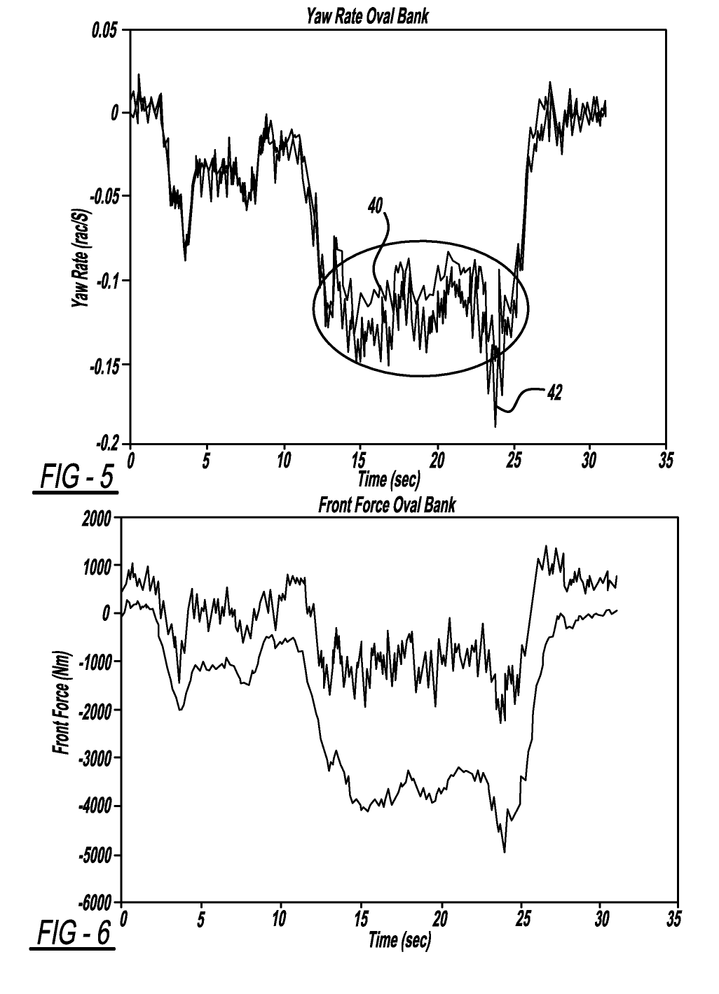

Similar to the above-mentioned unstable conditions, the presence of a road bank also results in changes in the values of these states, which might appear as error values to an ESC system. For example, the gravity weight component introduced due to the bank biases the sensors leading to an error being registered. In another exemplary case, a slow turn on ice may also be misinterpreted as a bank as the vehicle states, such as yaw rate and lateral acceleration, show similar behavior in these two situations. This analogy can be drawn by studying the variation of yaw rate values for a vehicle traveling on ice and on a banked road, as illustrated in FIGS. 3 and 5 discussed below. The first exemplary situation results in a failure to detect and compensate for the bank by the ESC system (false negative) while the second exemplary situation leads to an indication of a bank surface when one is not present (false positive), which results in delayed ESC activation and compensation. Both of these situations are undesirable.

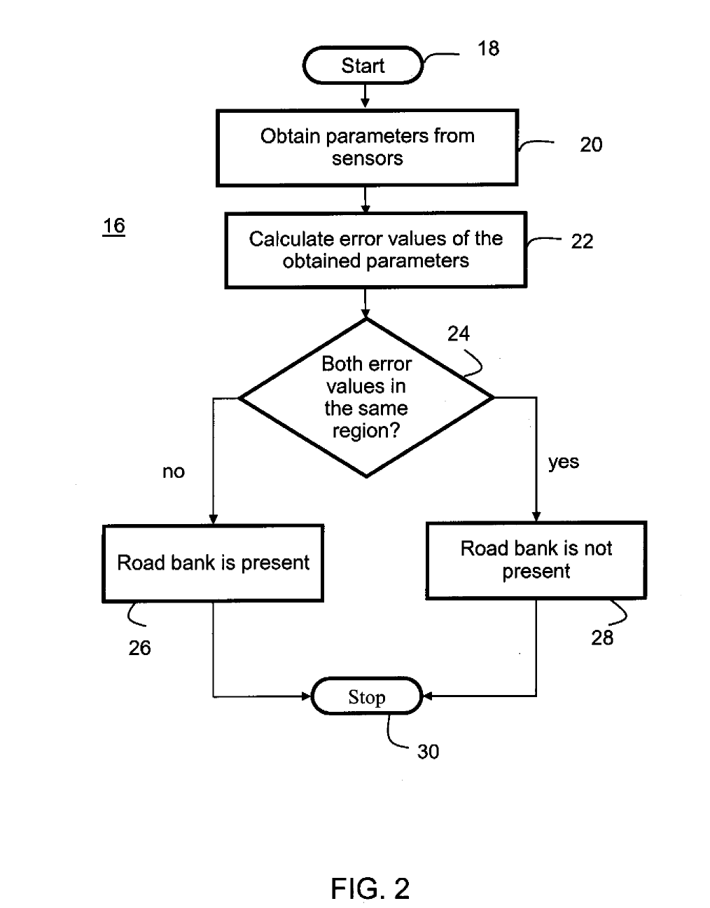

In accordance with the present invention, an algorithm, as shown by flow diagram 16 in FIG. 2, is used to ensure that the ESC systems do not get improperly biased, which may result in a false or delayed activation of the ESC system. The method is initiated at step 18. At step 20, sensors mounted on the vehicle 12 obtain states, such as vehicle yaw rate values and vehicle front axle force values. Yaw rate sensors are used to obtain yaw rate values and the front or rear axle force values are typically obtained with the help of standard ESC sensors mounted on the vehicle. Front and rear axle force values can be obtained by the following equation.

$$[ \begin{matrix}{F}_{yF} \\ {F}_{yR}\end{matrix} ] = {[ \begin{matrix}\frac{1}{m} & \frac{1}{m} \\ \frac{a}{{I}_{z}} & - \frac{b}{{I}_{z}}\end{matrix} ]}^{- 1} [ \begin{matrix}{a}_{y} \\ \dot{r}\end{matrix} ]$$

Where, F_{yF} is the front axle force value, F_{yR} is the rear axle force value, a_{y} is the lateral acceleration, and \dot{r} is the rate of change of the yaw rate.

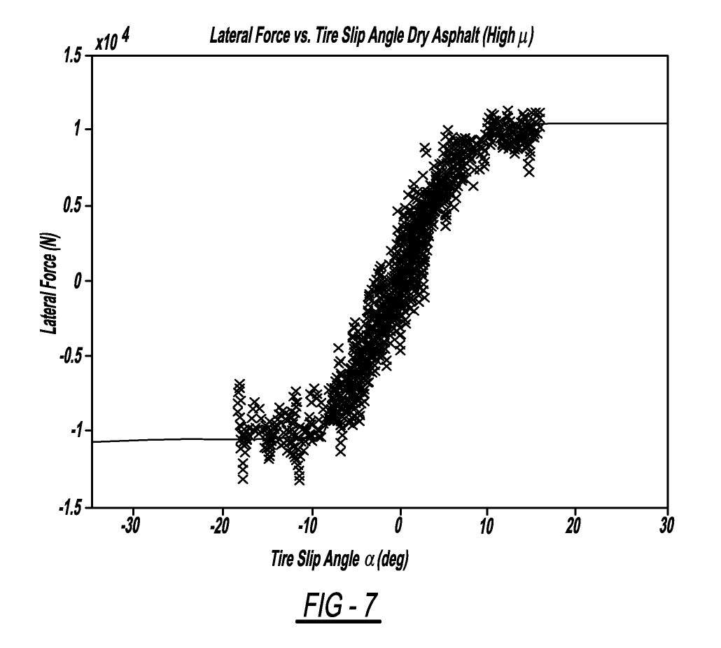

These values are used for comparison with the corresponding predetermined values for these states. The predetermined front axle force values are obtained from force tables, which can be generated as described below in FIG. 7. The predetermined yaw rate values are obtained using a theoretical dynamic model, referred to as a bicycle model. At step 22, error values corresponding to the yaw rate and front or rear axle force values are calculated. The error values are obtained by determining the difference between the obtained and the predetermined yaw rate and front axle force values, as shown in the following equations. Rear axle force values can be used instead of the front axle force values.

$${F}_{y , err} = {F}_{yF , table} - {F}_{yF , calc}$$

$${r}_{desired} = \frac{{v}_{x} δ}{L + {K}_{u} {v}_{x}^{2}}$$

$${r}_{err} = {r}_{desired} - {r}_{measured}$$

Where, F_{y,err} is the front axle force error, F_{yF,table} is the predetermined front axle force value, F_{yF,calc} is the calculated front axle force value, r_{desired} is the predetermined yaw rate value, r_{measured} is obtained yaw rate value, rₑᵣᵣ is yaw rate error value, vₓ is the vehicle speed, δ is the steering angle, L is wheel base of the vehicle, and Kᵤ is an understeer co-efficient.

The front or rear axle force error value and the yaw rate error value are then used to detect the presence of a road bank. If the presence of a bank is confirmed, a magnitude of the bank angle is calculated and based on this calculation, the vehicle yaw rate and the vehicle lateral velocity are compensated by the ESC system.

At step 24, a logical comparison between the magnitudes of the error values is performed. If the yaw rate error value and the front or rear axle force value are both in the same region, i.e., either both are high or both are low, then a road bank is not present, as shown at step 28. If the yaw rate error is low, but the front or rear axle force error is high, then a bank is present as shown in step 26. An exemplary graphical representation of the error values is shown in FIGS. 5 and 6.

In another exemplary embodiment, the presence of a road bank can be established by comparing an estimated rate of change of the lateral velocity obtained by using table look-ups, as is done for axle force values, and an obtained rate of change of lateral velocity obtained using ESC sensors. On flat surfaces, the values for the estimated and obtained rate of change of lateral velocity should be equivalent. On bank surfaces, there is a difference between the estimated and obtained rate of change of lateral velocity and the difference corresponds to the magnitude of the banked surface. Further, the rate of change of the lateral velocity can also be used for calculating the bank angle. The equations used in this embodiment are as follows.

First, the estimated values of rate of change lateral velocity are obtained by using the following equation.

$${\dot{v}}_{y , table} = \frac{{F}_{yF , table} + {F}_{yR , table}}{M} - {rv}_{x}$$

Where, v_{y,table} is the estimated rate of change of lateral velocity obtained from tables, M is the mass of the vehicle, vₓ is vehicle speed, r is yaw rate, F_{yF,table} is the pre-defined front axle force value obtained from the table, F_{yR,table} is the rear axle force value obtained from the table.

The rate of change of lateral velocity using sensors is given by the following equation.

\dot{v}_{y,calc}=a_{y}−rvₓ

Where, v_{y,calc} is the calculated rate of change of lateral velocity and r, vₓ and a_{y} are as described above.

Based on the estimated and obtained rate of change of the lateral velocity values, a rate of change of the lateral velocity error is calculated as:

$$\begin{matrix}{\dot{v}}_{y , err} = {\dot{v}}_{y , table} - {\dot{v}}_{y , calc} \\ = ( \frac{{F}_{yF , table} + {F}_{yR , table}}{M} - {rv}_{x} ) - ( {a}_{y} - {rv}_{x} ) \\ = \frac{{F}_{yF , table} + {F}_{yR , table}}{M} - {a}_{y}\end{matrix}$$

For flat surfaces, the error should be zero. In case the error is not zero, then an error term is formed which equals the bank angle as:

$${\dot{v}}_{y , err} = g sin {φ}_{b} = \frac{{F}_{yF , table} + {F}_{yR , table}}{M} - {a}_{y}$$

Where, v_{y,err} is the error in rate of change of lateral velocity, v_{y,calc} is the calculated rate of change of lateral velocity, v_{y,table} is the estimated rate of change of lateral velocity obtained from the table, a_{y} is lateral acceleration, g is acceleration due to gravity, Φ_{b} is the bank angle and M, F_{yF}, F_{yR}, r, vₓ are as described above.

The method is terminated at step 30. The calculations of the bank angle, vehicle yaw rate and vehicle lateral velocity compensation are shown below.

First, a rate of change of the lateral velocity is calculated using the following equations. For a level surface where measured and actual lateral acceleration are the same.

\dot{v}_{y}=a_{y,actual}−rvₓ

On a bank:

a_{y,measured}=a_{y,actual}−g sin φ_{b}

\dot{v}_{y}=a_{y,measured}+g sin φ_{b}−rvₓ

Under steady state:

$${\dot{v}}_{y} = {a}_{y , measured} + g sin {φ}_{b} - {rv}_{x} = 0$$

$$g sin {φ}_{b} = {rv}_{x} - {a}_{y , measured .} \\ ∴ {φ}_{b} = {sin}^{- 1} ( \frac{{rv}_{x} - {a}_{y , measured}}{g} )$$

In the above equations, \dot{v}_{y} is the rate of change of lateral velocity, a_{y,actual} is the actual lateral acceleration, a_{y,measured} is the measured lateral acceleration, g is acceleration due to gravity, Φ_{b} is the bank angle, vₓ is vehicle speed, and r is yaw rate.

The compensation for the bank can be done by calculating the desired lateral velocity value as detailed by the following equations.

$${δ}_{m} = {δ}_{actual} - {K}_{u} g sin {φ}_{b}$$

$${δ}_{actual} = \frac{r ( L + {K}_{u} {v}_{x}^{2} )}{{v}_{x}}$$

$${r}_{desired , bank} = \frac{{v}_{x}}{L + {K}_{u} {v}_{x}^{2}} ( {δ}_{m} + {K}_{u} g sin {φ}_{b} )$$

This leads to a rate of change of the lateral velocity being zero, where;

$${r}_{g} = ( \frac{{v}_{x}}{L + {K}_{u} {v}_{x}^{2}} )$$

$${r}_{desired , bank} = {r}_{desired} - {K}_{u} {r}_{g} ( {a}_{y} - {rv}_{x} )$$

Hence, a compensated lateral velocity can be calculated by the equations:

$${v}_{y , g} = {r}_{g} ( b - \frac{aM}{L} \frac{{v}_{x}^{2}}{{C}_{a r}} )$$

$${v}_{y , desired} = {δ}_{m} {v}_{y , g}$$

$${v}_{y , desired , bank} = {v}_{y , g} ( {δ}_{m} + {K}_{u} g sin {φ}_{b} )$$

Where, δₘ is the measured steering wheel angle, δ_{actual} is actual steering wheel angle, r_{desired,bank} is the compensated yaw rate, v_{desired} is the estimated lateral velocity (from tables), v_{desired,bank} is the compensated lateral velocity, M is the mass of the vehicle and vₓ, L, Kᵤ, r_{desired}, g, r and a_{y} are as described above.

FIGS. 3 and 4 are exemplary graphical representations of the variation of yaw rate and front axle force values, respectively, for a vehicle traveling on ice. FIG. 3 shows a variation of desired yaw rate values 32 and obtained yaw rate values 34 as a function of time for a slow turn of the vehicle moving on ice. FIG. 4 represents a variation of desired front axle force values 36 and obtained front axle force values 38 as a function of time for a slow turn of the vehicle moving on ice. The encircled area in both FIGS. 3 and 4 represent the error values for yaw rate and front axle force. From the shown graphs it becomes apparent that the yaw rate and front axle errors between the desired values and obtained values appear simultaneously, which is equivalent to the situation where the vehicle is traveling on a banked road as illustrated in FIGS. 5 and 6.

FIGS. 5 and 6 are exemplary graphical representations of variation of yaw rate values and front axle force values for a vehicle traveling on a banked road. FIG. 5 shows the variation of desired yaw rate values 40 and obtained yaw rate values 42 as a function of time for a vehicle moving on a banked asphalt road. FIG. 6 represents the variation of desired front axle force values 44 and obtained front axle force values 46 as a function of time for a vehicle moving on a banked asphalt road. The encircled area in both of the FIGS. 5 and 6 represents the error values for yaw rate and front axle force. From these graphs it becomes apparent that the yaw rate and front axle errors between the desired and obtained values appear simultaneously. Further the magnitude of the front axle force error value is large while the yaw rate error is minimal in comparison. This difference in magnitudes of error values establishes the presence of a road bank.

FIG. 7 shows an exemplary graphical variation of front lateral force values as a function of front axle slip angle for a vehicle traveling on a road. This graph is obtained by plotting the front axle slip angle values and the front axle force values. The front axle force value are obtained by performing nonlinear handling maneuvers while measuring lateral acceleration, yaw rate, steering wheel angle, longitudinal, and lateral velocity.

The lateral acceleration measurement is compensated for gravity due to vehicle roll using a one degree of freedom vehicle roll dynamics model, as shown in the equations below.

$${a}_{y , compensated} = {a}_{y , measured} - {f}_{roll} ( {a}_{y , measured} ) \\ ∵ \{ \frac{{f}_{roll}}{{a}_{y , measured}} \} = \frac{{d}_{1}}{{s}^{2} + {c}_{1} s + {c}_{2}}$$

Where a_{y,compensated} is the compensated lateral acceleration, and a_{y,measured} is the measured lateral acceleration.

Front and rear axle forces are calculated from lateral acceleration and yaw rate measurements using the following equations.

$$[ \begin{matrix}{F}_{yF} \\ {F}_{yR}\end{matrix} ] = {[ \begin{matrix}\frac{1}{m} & \frac{1}{m} \\ \frac{a}{{I}_{z}} & - \frac{b}{{I}_{z}}\end{matrix} ]}^{- 1} [ \begin{matrix}{a}_{y , compensated} \\ \dot{r}\end{matrix} ]$$

Lateral velocity measurement is compensated for roll motion using roll rate information as shown in the following equation.

v_{y,compensated}=v_{y,measured}+c_{vy,rr}p

Where, v_{y,compensated} is the compensated lateral velocity, v_{y,measured} is the compensated lateral velocity, and p is the measured roll rate.

If roll rate measurement is not available, estimated roll rate is used instead with the following equations.

$${p}_{estimated} = {f}_{rollrate} ( {a}_{y , measured} ) \\ ∵ \{ \frac{{f}_{rollrate}}{{a}_{y , measured}} \} = \frac{{d}_{1} s}{{s}^{2} + {c}_{1} s + {c}_{2}}$$

Where, p_{estimated} is the estimated roll rate.

Front and rear axle slip angles are computed based on the following kinematic equations between lateral velocity and axle slip angles.

$${α}_{F} = {tan}^{- 1} ( \frac{{v}_{y , compensated} + ar}{{v}_{x}} ) - δ , {α}_{R} = {tan}^{- 1} ( \frac{{v}_{y , compensated} - br}{{v}_{x}} )$$

Where, α_{f} is the front axle slip angle, αᵣ is the rear axle slip angle, v_{y,compensated}, v_{y,measured}, vₓ, δ, r are as described above.

Front and rear axle lateral forces versus axle slip angle tables are generated using calculated forces and slip angles. The table data can be fit with a non-linear function of the following type.

$${F}_{y} = {f}_{table} ( a , μ )$$

$$e . g . {F}_{yF} = {c}_{F} μ tanh ( \frac{{d}_{F}}{μ} {α}_{F} ) , {F}_{yR} = {c}_{R} μ tanh ( \frac{{d}_{r}}{μ} {α}_{R} )$$

Where, μ is co-efficient of friction and αᵣ is rear axle slip angle.

Various embodiments of the present invention offer one or more advantages. The present invention provides a method for road bank detection for use in vehicle stability control systems. The method of the present invention helps in devising ESC systems that are capable of differentiating between unstable vehicle conditions and the presence of a bank and also are capable of activation in low coefficient of friction p conditions to help in better stability control of a moving vehicle for enhanced safety of its occupants.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A method for detecting a road bank, said method comprising:
obtaining a vehicle yaw rate value and a front and/or rear axle force value for a vehicle travelling on the road;
comparing the obtained vehicle yaw rate value with a predetermined vehicle yaw rate value to obtain a vehicle yaw rate error value and comparing the obtained vehicle front and/or rear axle force value with a predetermined vehicle front and/or rear axle force value to obtain a vehicle front and/or rear axle force error value; and
detecting the road bank based on the vehicle yaw rate error value and the vehicle front and/or rear axle force error value.

2. The method according to claim 1 wherein the vehicle yaw rate value is obtained using a yaw rate sensor.

3. The method according to claim 1 wherein the vehicle front and/or rear axle force value is obtained using an electronic stability control (ESC) system sensor.

4. The method according to claim 1 wherein the predetermined vehicle yaw rate value is estimated using a bicycle model.

5. The method according to claim 1 wherein the predetermined vehicle front and/or axle force value is obtained based on an arranged set of data, wherein the arranged set of data is a representation of a set of vehicle front and/or rear axle lateral force values corresponding to a set of vehicle slip angle values.

6. The method according to claim 5 wherein the arranged set of data is provided in a table.

7. The method according to claim 5 wherein the arranged set of data is provided by a graph.

8. A method for detecting of a road bank, said method comprising:
obtaining a rate of change of lateral velocity of a vehicle travelling on the road using an arranged set of data;
calculating a rate of change of lateral velocity of the vehicle using an electronic stability control (ESC) system sensor;
comparing the obtained rate of change of lateral velocity and the calculated rate of change of lateral velocity; and
detecting the banking of the road based on the comparison between the obtained rate of change of lateral velocity and the calculated rate of change of lateral velocity.

9. The method according to claim 8 wherein the arranged set of data is a representation of a set of vehicle front and/or rear axle lateral force values corresponding to a set of vehicle slip angle values.

10. The method according to claim 9 wherein the arranged set of data is provided in a table.

11. The method according to claim 9 wherein the arranged set of data is provided by a graph.

12. A method for detecting a road bank, and for compensating yaw rate and lateral velocity for facilitating stability control of a vehicle travelling on the road, said method comprising:
obtaining a yaw rate value and a front and/or rear axle force value for the vehicle;
comparing the vehicle yaw rate value with a predetermined vehicle yaw rate value to obtain a vehicle yaw rate error value and comparing the vehicle front axle force value with a predetermined vehicle front and/or rear axle force value to obtain a vehicle front axle force error value;
detecting the bank of the road based on the obtained vehicle yaw rate error value and the front and/or rear axle force error value;
calculating a banking angle of the road based on the obtained vehicle yaw rate error value and the vehicle front and/or rear axle force error value; and
compensating the vehicle yaw rate and the vehicle lateral velocity based on the banking angle of the road.

13. The method according to claim 12 wherein the vehicle yaw rate value is obtained using a yaw rate sensor.

14. The method according to claim 12 wherein the vehicle front axle force value is obtained using an electronic stability control (ESC) system sensor.

15. The method according to claim 12 wherein the predetermined vehicle yaw rate value is estimated using a bicycle model.

16. The method according to claim 12 wherein the predetermined set of vehicle front axle force value is obtained from an arranged set of data, the arranged set of data being a representation of a set of vehicle front and/or rear axle lateral force values corresponding to a set of vehicle slip angle values.

17. The method according to claim 16 wherein the arranged set of data is provided in a table.

18. The method according to claim 16 wherein the arranged set of data is provided by a graph.

19. The method according to claim 12 wherein the vehicle yaw rate and the vehicle lateral velocity are compensated by application of brakes on wheels of the vehicle.

20. The method according to claim 12 wherein the vehicle yaw rate and vehicle lateral velocity are compensated by reducing power of an engine of the vehicle.
